(19) United States
(12) Patent Application Publication
(10) Pub. No.: US 2022/0126247 A1
(43) Pub. Date: Apr. 28, 2022

(54) A TRIPHASIC REACTOR

(71) Applicant: EVONIK OPERATIONS GMBH, Essen (DE)

(72) Inventors: Thomas HAAS, Münster (DE); Christian HYING, Rhede (DE); Matthias PASCALY, Münster (DE); Sebastian IMM, Bad Vilbel (DE); Holger WIEDERHOLD, Darmstadt (DE)

(21) Appl. No.: 17/428,785

(22) PCT Filed: Feb. 6, 2020
(86) PCT No.: PCT/EP2020/053043

§ 371 Date: Aug. 5, 2021

(30) Foreign Application Priority Data
Feb. 8, 2019 (EP) 19156177.8

(51) Int. Cl. B01J 8/00; B01J 35/06; B01J 21/06; B01J 19/32

(52) U.S. Cl. CPC B01J 8/008; B01J 19/32; B01J 21/063; B01J 35/06

(57) ABSTRACT

The present invention relates to a triphasic single reactor comprising a solid, a liquid and a gaseous component, wherein the
(i) the solid component is (a) a catalytically active composite based on (b) at least one perforated and permeable support, wherein the catalytically active composite is on at least one side of the support and inside the support and
   (a) the catalytically active composite is obtained by applying a suspension comprising at least one inorganic component of
      a compound of at least one of the elements Ce, La Sc, Y, Ti, Zr, Hf, Rf, V, Nb, Ta, Db, Cr, Mo, W, Sg, Mn, Tc, Re, Bh, Fe, Co, B, Al, In, Tl, Si, Ge, Sn, Pb, Sb and Bi with at least one of the elements Te, Se, S, O, Sb, As, P, N, Ge, Si, C and Ga and/or
      a compound of one of the elements Ti, Zr, Al, Ce and Si with oxygen, and/or
      a metal selected from Pt, Rh, Ru, Ir, Cu, Ni, Co, Mg, Zn, Al and Pd,
   in suspension in a sol, and
   (b) the support comprises fibers of at least one material selected from the group consisting of carbon, metal, alloy, ceramic, glass, mineral, plastic, amorphous substance, composite, natural product, and a combination thereof and heating the support at least once to a temperature of between 100 to 800° C. for 10 minutes to 5 hours, during which the suspension comprising the inorganic component is solidified on and inside the support.

### FIELD OF THE INVENTION

The present invention relates to a triphasic reactor that may be used for reacting an organic compound. In particular, the triphasic reactor is capable of carrying out the reaction of the organic compound in the presence of a catalytic solid, a liquid and a gaseous component.

### BACKGROUND OF THE INVENTION

Gas-liquid multiphase catalytic reactions such as oxidation, hydrogenation and halogenation are especially important in the pharmaceutical and fine chemical industries. These reactions involve the contact of gaseous, liquid and solid components and are traditionally carried out in stirred batch reactors, at high stirring rates and under harsh reaction conditions of elevated temperature and pressure to overcome severe heat and mass transfer limitations. Also, to ensure that the solid, liquid and gas components are in constant contact to enable the reaction to be carried out, the reaction mixture is constantly stirred. Even then, the reactions are not always efficient and the yield low.

In particular, the traditional catalysts used in these reactions are destroyed by the harsh conditions of the reaction and are not able to perform at their best. Accordingly, the presently available multiphase reactors have several drawbacks including catalyst recovery and recycling of the catalyst which remains a challenge, especially where the products, unreacted starting materials, and catalyst co-exist in the same liquid phase. Moreover, catalyst deactivation shortens the shelf life of the reactors.

Accordingly, there is a need in the art for a simple and economical triphasic reactor that is not only able to bring three phases into contact but also enable the catalyst to be recovered and recycled for further reactions. In particular, there is a need in the art for a triphasic reactor that is capable of improving the yield of the desired product produced compared to the methods known in the art.

### DESCRIPTION OF THE INVENTION

The present invention attempts to solve the problems above by providing a triphasic reactor that comprises as a solid phase a catalytically active composite material on and in a support where the catalyst will be able to withstand the conditions of the reaction(s) that may be carried out in the triphasic reactor.

According to one aspect of the present invention, there is provided a triphasic single reactor comprising a solid, a liquid and a gaseous component, wherein the
(i) the solid component is (a) a catalytically active composite based on (b) a support, wherein the catalytically active composite is on at least one side of the support and in the interior of the support and
   (a) the catalytically active composite is obtained by applying a suspension comprising at least one inorganic component of
      a compound of at least one of the elements Ce, La Sc, Y, Ti, Zr, Hf, Rf, V, Nb, Ta, Db, Cr, Mo, W, Sg, Mn, Tc, Re, Bh, Fe, Co, B, Al, In, Tl, Si, Ge, Sn, Pb, Sb and Bi with at least one of the elements Te, Se, S, O, Sb, As, P, N, Ge, Si, C and Ga and/or
      a compound of one of the elements Ti, Zr, Al, Ce and Si with oxygen, and/or
      a metal selected from Pt, Rh, Ru, Ir, Cu, Ni, Co, Mg, Zn, Al and Pd,
   in suspension in a sol, and
   (b) the support comprises fibers of at least one material selected from the group consisting of carbon, metal, alloy, ceramic, glass, mineral, plastic, amorphous substance, composite, natural product, and a combination thereof.

The ‘interior of the support’ may be used interchangeably with the phrase ‘inside of the support’ and as used herein refers to the hollows or pores in a support.

The support may be heated at least once to a temperature of between 100 to 800° C. for 10 minutes to 5 hours, during which the suspension comprising the inorganic component is solidified on and inside the support. This step of heating, stabilizes the suspension containing the inorganic component onto or into or onto and into the support. The composite on the support made this way can be produced simply and at a reasonable price. In particular, the suspension that is present on or in or on and in the support can be stabilized by heating the support with the suspension to between 50 and 1000° C. In one example, the support with the suspension on the support is subjected to a temperature of 50-800, 100-800, 200-800, 300-800, 400-800, 500-800, 600-800, 50-700, 100-700, 200-700, 300-700, 400-700, 600-700, 50-600, 100-600, 200-600, 300-600, 400-600, 500-600, 50-500, 100-500, 200-500, 300-500, 400-500, 50-400, 100-400, 200-400, 300-400, 50-300, 100-300, 200-300° C. or the like for at least 10 minutes to 5 hours. In one example, the support with the suspension comprising the inorganic component according to any aspect of the present invention may be subjected to this high temperature for at least about 10, 15, 20, 25, 30, 35, 40, 45, 50, 55 or 60 mins, or 1 h, 1.5 hrs, 2 hrs, 2.5 hrs, 3 hrs, 3.5 hrs, 4 hrs, 4.5 hrs or 5 hrs. The support with the suspension comprising the inorganic component according to any aspect of the present invention may be subjected to this high temperature for 15 mins-5 hrs, 30 mins-5 hrs, 1-5 hrs, 2-5 hrs, 3-5 hrs, 4-5 hrs, 15 mins-4 hrs, 30 mins-4 hrs, 1-4 hrs, 2-4 hrs, 3-4 hrs, 15 mins-3 hrs, 30 mins-3 hrs, 1-3 hrs, 2-3 hrs, 15 mins-2 hrs, 30 mins-2 hrs, 1-2 hrs, 15 mins-1 hr, 30 mins-1 hr or the like.

In one particular example, the support with the suspension comprising the inorganic component according to any aspect of the present invention may be subjected to a temperature of between 100 to 500° C. for 1 hour. In a further example, the support with the suspension comprising the inorganic component according to any aspect of the present invention may be subject to a temperature of between 100 and 800° C. for 1 second to 10 minutes.

Heating the support with the suspension comprising the inorganic component according to any aspect of the present invention may be carried out by means of warmed air, hot air, infrared radiation, microwave radiation, or electrically generated heat. In one example, the heating of the support may be carried out using the support material as electric resistance heating. For this purpose, the support may be connected to an electrical power source by at least two contacts. Depending on the strength of the power source and the voltage released, the support heats up when the power is switched on, and the suspension that is present in and on the surface of the support may be stabilized by this heat.

In a further example, stabilization of the suspension can be achieved by applying the suspension onto or into or onto and into a preheated support thus stabilizing the suspension immediately upon application.

As used herein, the terms “about” and “approximately”, refer to a range of values that are similar to the stated reference value for that condition. In certain examples, the term “about” refers to a range of values that fall within 25, 20, 19, 18, 17, 16, 15, 14, 13, 12, 11, 10, 9, 8, 7, 6, 5, 4, 3, 2, 1 percent or less of the stated reference value for that condition. For example, a temperature employed during the method according to any aspect of the present invention when modified by “about” includes the variation and degree of care typically employed in measuring in an experimental condition in production plant or lab. For example, the temperature when modified by “about” includes the variation between batches in multiple experiments in the plant or lab and the variation inherent in the analytical method.

In particular, the support is perforated and/or permeable. The permeable composites and/or supports are materials that are permeable for substances with a particle size of between 0.5 nm and 500 μm, depending on the style of execution of the composite or support respectively. The substances can be gaseous, liquid or solid or in a mixture of these states of aggregation.

The composite according to any aspect of the present invention also has the advantage that the support with perforated surfaces with a maximum gap size of 500 μm can be coated.

The catalytically active composite according to any aspect of the present invention has the advantage that inorganic components in the suspension can be stabilized on and in a perforated and permeable support, which consequently allows the composite to have permeable properties, without the coating being damaged during production. Accordingly, the composite according to any aspect of the present invention also has the advantage that, although it partly consists of a ceramic material, it can be bent to a radius of up to 1 mm. This property enables an especially simple process of producing this composite, as the composite created by coating with a ceramic material can be wound on or off a roll. The possibility of also being able to use supports that have gaps with a size of up to 500 μm allows the use of exceptionally reasonably priced materials. The particle size used in combination with the gap size of the support material used allows the pore size and/or the pore size distribution to be easily adjusted in the composite according to any aspect of the present invention depending on the reactants used.

In particular, the perforated and permeable support can have gap sizes of between 0.02 and 500 μm. The gaps can be pores, mesh, holes, crystal lattice gaps or hollows. The support may comprise at least one material selected from the group consisting of carbon, metal, alloy, ceramic, glass, mineral, plastic, amorphous substance, composite, natural product, and a combination thereof. The support, which can contain the above-mentioned materials, could have been modified by a chemical, thermal, or mechanical treatment or a combination of treatments. In particular, the catalytically active composite according to any aspect of the present invention may comprise a support, which comprises at least one metal, a natural fiber or a plastic, which has been modified by at least one mechanical deformation or treatment technology respectively, such as drawing, swaging, flex-leveling, milling, stretching or forging. In one example, the catalytically active composite according to any aspect of the present invention comprises at least one support that has at least woven, glued, felted or ceramically bound fibers or at least sintered or glued formed bodies, spheres or particles. In another example, a perforated support may be used. Permeable supports can also be supports that become or were made permeable by laser or ion beam treatment.

In particular, the support according to any aspect of the present invention comprises fibers from a material selected from the group consisting of carbon, metal, alloy, ceramic, glass, mineral, plastic, amorphous substance, composite, natural product, and a combination thereof. In one example, the support may comprise fibers consisting of at least one combination of these materials, such as asbestos, glass fibers, carbon fibers, metal wires, steel wires, rock wool fibers, polyamide fibers, coconut fibers, coated fibers. More in particular, supports are used that at least contain woven fibers made of metal or alloys. Metal fibers can also be wires. Even more in particular, the support according to any aspect of the present invention may have at least one mesh made of steel or stainless steel, such as, for example, steel wire, stainless steel wire, or stainless steel fiber meshes produced by weaving. The mesh size may be between 5 and 500 μm, 50 and 500 μm or 70 and 120 μm.

The permeable catalytically active composite according to any aspect of the present invention may be obtained by the application of a suspension containing at least one inorganic component,
a compound of at least one of the elements Ce, La Sc, Y, Ti, Zr, Hf, Rf, V, Nb, Ta, Db, Cr, Mo, W, Sg, Mn, Tc, Re, Bh, Fe, Co, B, Al, In, Tl, Si, Ge, Sn, Pb, Sb and Bi with at least one of the elements Te, Se, S, O, Sb, As, P, N, Ge, Si, C and Ga and/or
a compound of one of the elements Ti, Zr, Al, Ce and Si with oxygen, and/or
a metal selected from Pt, Rh, Ru, Ir, Cu, Ni, Co, Mg, Zn, Al and Pd, in suspension in a sol
   on at least one perforated and permeable support, which may be subsequently heated at least once to stabilize the suspension containing the inorganic component on or in or on and in the support. In particular, the suspension may be applied onto and into or onto or into at least one support by stamping on, pressing on or in, rolling on, applying with a blade or a brush, dipping, spraying or pouring.

In one example, the permeable composite according to any aspect of the present invention can also be obtained by chemical vapour deposition, impregnation, or co-precipitation. The permeable composite according to any aspect of the present invention can be permeable for gases, ions, solids or liquids, whereby the composite can be permeable for particles with a size of between 0.5 nm and 10 μm.

The inorganic component contained in the composite according to any aspect of the present invention can contain at least one compound of at least one metal, metalloid, composition metal or a mixture thereof, whereby these compounds have a particle size of between 0.001 and 25 μm. In one example, it may be advantageous if at least one inorganic component having a particle size of between 1 and 10000 nm may be suspended in at least one sol according to any aspect of the present invention. In particular, the inorganic component according to any aspect of the present invention contains at least one compound of at least one of the elements Sc, Y, Ti, Zr, V, Nb, Cr, Mo, W, Mn, Fe, Co, B, Al, Ga, In, Tl, Si, Ge, Sn, Pb, Sb or Bi with at least one of the elements Te, Se, S, O, Sb, As, P, N, C, Si, Ge or Ga, such as, for example, TiO₂, Al₂O₃, SiO₂, ZrO₂, Y₂O₃, BC, SiC, Fe₃O₄, SiN, SiP, nitrides, sulfates, phosphides, silicides, spinels or yttrium aluminum garnet, or one of these elements itself. The inorganic component can also have alumosilicates, aluminumphosphates, zeolites or partially substituted zeolites, such as, for example, ZSM-5, Na-ZSM-5 or Fe-ZSM-5 or amorphous microporous mixed oxide systems, which can contain up to 20% non-hydrolyzable organic compounds, such as, for example, vanadium oxide-silicium oxide-glass or aluminum oxide-silicium oxide-methyl silicium sesquioxide-glasses.

In one example, the composite according to any aspect of the present invention comprises at least one oxide from at least one of the elements Mo, Sn, Zn, V, Mn, Fe, Co, Ni, As, Sb, Pb, Bi, Ru, Re, Cr, W, Nb, Hf, La, Ce, Gd, Ga, In, Tl, Ag, Cu, Li, K, Na, Be, Mg, Ca, Sr and Ba as a catalytically active composite.

In particular, there is at least one inorganic component in a particle size fraction with a particle size of between 1 and 250 nm or with a particle size of between 260 and 10000 nm in the suspension according to any aspect of the present invention. In one example, the composite according to any aspect of the present invention comprises at least two particle size fractions of the inorganic component. In yet another example, the composite according to any aspect of the present invention comprises at least two particle size fractions of at least two different inorganic components. The particle size proportion can be between 1:1 and 1:10000, or between 1:1 and 1:100. The proportion of ingredients of the particle size fraction in the composite can be between 0.01:1 and 1:0.01.

The permeability of the composite according to any aspect of the present invention may be limited by the particle size of the inorganic component used to particles with a certain maximum size.

The fracture resistance in the composite according to any aspect of the present invention may be optimized by a suitable choice of the particle size of the suspended compounds in dependence on the size of the pores, holes or gaps of the perforated permeable support, but also by the layer thickness of the composite according to any aspect of the present invention as well as by the proportional ratio of sol, solvent and metallic oxide.

In one example, when using a mesh with a mesh width of, for example, 100 μm, the fracture resistance can be increased by the use of suspensions containing a suspended compound with a particle size of at least 0.7 μm. In general, the ratio of particle size to mesh or pore size respectively should be between 1:1000 and 50:1000. The composite according to any aspect of the present invention can have a thickness of between 5 and 1000 μm, in particular, a thickness of between 50 and 150 μm. The suspension consisting of sol and compounds to be suspended may have a ratio of sol to compounds to be suspended of 0.1:100 to 100:0.1, or 0.1:10 to 10:0.1 parts by weight.

The suspension containing the inorganic component according to any aspect of the present invention, which allows the composite according to any aspect of the present invention to be obtained, can contain at least one liquid selected from the group consisting of water, alcohol, acid and a combination thereof.

In one example, composite according to any aspect of the present invention may be constructed in such a way that it may be bent without the inorganic components stabilized on the inside of the support and/or on the support being destroyed. The composite according to any aspect of the present invention may be flexible to a smallest radius of up to 1 mm. However, the composite can also have at least one expanded metal with a pore size of between 5 and 500 μm. According to any aspect of the present invention, the support may also have at least one granular sintered metal, one sintered glass or one metal web with a pore width of between 0.1 μm and 500 μm, in particular between 3 and 60 μm.

The sols according to any aspect of the present invention may be obtained by hydrolysing at least one compound that is part of inorganic component, particularly at least one metallic compound, at least one metalloid compound or at least one composition metallic compound with at least one liquid, one solid or one gas, whereby it can be advantageous if as a liquid water, alcohol or an acid, as a solid ice or as a gas water vapour or at least one combination of these liquids, solids or gases is used. It could also be advantageous to place the compound to be hydrolysed in alcohol or an acid ora combination of these liquids before hydrolysis. In one example, as a compound to be hydrolysed at least one metal nitrate, one metal chloride, one metal carbonate, one metal alcoholate compound or at least one metalloid alcoholate compound may be used. In particular, at least one metal alcoholate compound, one metal nitrate, one metal chloride, one metal carbonate or at least one metalloid alcoholate compound from compounds of the elements Ti, Zr, Al, Si, Sn, Ce and Y or the lanthanides and actinides, such as, for example, titanium alcoholates, such as, for example, titanium isopropylate, silicium alcoholates, zirconium alcoholates, or a metallic nitrate, such as, for example, zirconium nitrate may be hydrolysed to product a sol according to any aspect of the present invention.

It may be advantageous to carry out the hydrolysis of the compounds according to any aspect of the present invention to be hydrolyzed with at least half the mol ratio water, water vapour or ice in relation to the hydrolyzable group of the hydrolyzable compound. For peptizing, the hydrolyzed compound can be treated with at least one organic or inorganic acid. In one example, with a 10 to 60% organic or inorganic acid, in particular with a mineral acid from the following: sulfuric acid, hydrochloric acid, perchloric acid, phosphoric acid and azotic acid or a mixture of these acids.

Not only sols produced as described above can be used, but also commercially available sols such as titanium nitrate sol, zirconium nitrate sol or silica sol may be used in the suspension according to any aspect of the present invention. In one example, the percentage by mass of the suspended component according to any aspect of the present invention may be 0.1 to 500 times the hydrolyzed compound used.

The support according to any aspect of the present invention onto or into or onto and into which at least one suspension may be applied, may contain at least one of the following materials carbon, metals, alloys, glass, ceramic materials, minerals, plastics, amorphous substances, natural products, composites or at least one combination of these materials. In particular, supports may be used that comprises or consists of mesh made of fiber or wire made from the above-mentioned materials such as, for example, metallic or plastic mesh. The composite according to any aspect of the present invention may have at least one support that has at least one of the of following aluminum, silicium, cobalt, manganese, zinc, vanadium, molybdenum, indium, lead, bismuth, silver, gold, nickel, copper, iron, titanium, platinum, stainless steel, steel, brass, an alloy of these materials or a material coated with Au, Ag, Pb, Ti, Ni, Cr, Pt, Pd, Rh, Ru and/or Ti.

Methods that may be used to produce the solid component according to any aspect of the present invention are provided at least in WO1999015272A1.

In one example, the support according to any aspect of the present invention may be rolled from a roll and—at a speed of between 1 m/h and 1 m/s—runs through at least one device that applies the suspension onto or into or onto and into the support and through at least one other device that enables the suspension according to any aspect of the present invention to be stabilized onto or into or onto and into the support by heating, and that the composite produced in this way is rolled onto a second roll. In this way it is possible to produce the composite according to any aspect of the present invention in a continuous process.

In a further example, the inorganic layer according to any aspect of the present invention may be a green (unsintered) layer of ceramic material or an inorganic layer, for example, which can, for example, be on an auxiliary film, that may be laminated onto the support or the composite treated with another suspension as described above. This composite may be stabilized by heating, for example, by infrared radiation or in a kiln.

The green ceramic material layer that is used may contain nanocrystalline powder from at least one metalloid oxide or metallic oxide, such as, for example, aluminum oxide, titanium dioxide or zirconium dioxide. The green layer can also contain an organic bonding agent.

By using a green ceramic material layer it is a simple matter to provide the composite according to any aspect of the present invention with an additional ceramic layer, which—according to the size of the nanocrystalline powder used—limits the permeability of the composite produced in this way to smallest particles. The green layer of nanocrystalline powder may have a particle size of between 1 and 1000 nm. If nanocrystalline powder with particle sizes of between 1 and 10 nm is used, the composite according to any aspect of the present invention, onto which an additional ceramic layer has been applied, may have a permeability for particles with a size corresponding to the particle size of the powder that was used. If nanocrystalline powder with a size of more than 10 nm is used, the ceramic layer is permeable for particles that are half as large as the particles of the nanocrystalline powder that was used.

By applying at least one other inorganic layer (i.e. that there may be at least two inorganic components) as part of the composite according to any aspect of the present invention, a composite according to any aspect of the present invention may be obtained that has a pore gradient. To produce composites with a defined pore size, it may also be possible to use supports, whose pore or mesh size respectively is not suitable for the production of a composite with the required pore size, if several layers are applied. This can, for example, be the case when a composite with a pore size of 0.25 μm is to be produced using a support with a mesh width of more than 300 μm. To obtain such a composite it can be advantageous to apply at least one suspension on the support, which is suitable for treating supports with a mesh width of 300 μm and stabilizing this suspension after application. The composite obtained in this way can then be used as a support with a smaller mesh or pore size respectively. Another suspension, for example, that contains, for example, a compound with a particle size of 0.5 μm can be applied to this support.

The fracture indifference of composites with large mesh or pore widths respectively can also be improved by applying suspensions to the support that contain at least two suspended compounds. Preferably, suspended compounds are used that have a particle size ratio of 1:1 to 1:10, particularly, a ratio of between 1:1.5 and 1:2.5. The proportion by weight of the particle size fraction with the smaller particle size should not exceed a proportion of 50% at the most, in particular 20% and more in particular, 10% of the total weight of the particle size fraction. In spite of an additional layer of inorganic material being applied to the support, the composite according to any aspect of the present invention can be flexible.

The composite according to any aspect of the present invention can also be produced by placing a support, that can be, for example, a composite according to any aspect of the present invention or another suitable support material, onto a second support that can be the same material as the first support or another material or two supports of different permeability or porosity respectively. A spacer, a drainage material or another material suitable for material conduction, for example, a mesh composite, can be placed between the two support materials. The edges of both supports are connected to each other by various processes, for example, soldering, welding or adhering. Adhering can be done with commercially available bonding agents or adhesive tape. The suspension can then be applied to the support composite that has been produced in the above-mentioned ways.

In one example, the two supports placed on top of each other with at least one spacer, drainage material or similar material placed between them, can be rolled up before or after joining the edges of the support, particularly after joining. By using thicker or thinner adhesive tape to join the edges of the support, the space between the two carrier composites that are placed on top of each other can be influenced during rolling. A suspension as described above can be applied to such support composites that have been rolled up in this way, for example, by dipping in a suspension. After dipping, the support composite can be freed of surplus suspension with the aid of compressed air. The suspension that has been applied to the carrier composite can be stabilized in the above-mentioned manner. A composite produced in the above-mentioned manner can be used in a wound module as a form-selective membrane.

In a further example, the above-mentioned support composite can also be produced when two supports and, if intended, at least one spacer are rolled from one roll and then placed on top of each other. The edges can again be joined by soldering, welding or adhesion or other suitable processes of joining flat bodies. The suspension can then be applied to the support composite produced in this manner. This can be done, for example, by the support composite being sprayed or painted with the suspension or the support composite being drawn through a bath containing the suspension. The applied suspension is stabilized according to one of the above-mentioned processes. The composite produced in this way can be wound onto a roll. Another inorganic layer can be applied into and/or onto such a material by a further application and stabilization of a further suspension. Using different suspensions allows the material properties to be adjusted according to wish or intended use respectively. Not only further suspensions can be applied to these composites, but also unsintered ceramic and/or inorganic layers, which are obtainable by lamination in the above-mentioned way may be applied. The process used to produce the solid component according to any aspect of the present invention can be carried out continuously or intermittently. A composite produced in this way can be used as a form-selective membrane in a flat module. A skilled person would be capable of varying the process of producing the solid component according to any aspect of the present invention based on the reaction and/or reactants that are to be used.

In one example, the support in the solid component according to any aspect of the present invention may, depending on the support material, be removed again thus creating a ceramic material/composite that has no further trace of support material. For example, if the support is a natural material such as a cotton fleece, this can be removed from the solid component and the composite in a suitable reactor by oxidation. If the support material is a metal, such as, for example, iron, this support can be dissolved by treating the solid component with acid, preferably with concentrated hydrochloric acid. If the composite was also made from zeolite, flat zeolite bodies can be produced that are suitable for form-selective catalysis.

It can be advantageous to use the composite according to any aspect of the present invention as a support for the production of the solid component according to any aspect of the present invention.

In one example, it may be possible to combine different methods of producing the solid component according to any aspect of the present invention.

In particular, the catalytically active composite in the (i) solid component may be capable of being wound on or off a roll.

The reactor according to any aspect of the present invention also comprises a liquid and gas component, wherein
(ii) the liquid component comprises an aqueous reaction solution, and
(iii) the gas component comprises at least one gas.

The liquid component may be an aqueous reaction solution that comprises at least one organic compound that is to be used as a substrate in the reaction. The term ‘aqueous organic compound’ may be used interchangeably with an ‘aqueous organic solution’ and refers to an organic compound in solution. The term “an aqueous solution” comprises any solution comprising water, mainly water as solvent that may be used to dilute the reactant or organic compound that is to be used as a substrate according to any aspect of the present invention. The aqueous solution may also comprise any additional substrates that may be needed for the organic component to undergo a reaction. The person skilled in the art is familiar with the preparation of numerous aqueous solutions. It is advantageous to use as an aqueous solution a minimal medium, i.e. a medium of reasonably simple composition that comprises only the minimal set of salts and nutrients indispensable for the reaction to be carried out, to avoid dispensable contamination of the products with unwanted side products.

In particular, the organic compound present according to any aspect of the present invention may be selected from the group consisting of alkanes, alkenes, carboxylic acids, dicarboxylic acids, hydroxycarboxylic acids, carboxylic acid esters, hydroxycarboxylic acid esters, alcohols, aldehydes, ketones, amines and amino acids. The organic compound may be a substituted or unsubstituted compound that may be able to go through the process of reduction or oxidation.

The gas component according to any aspect of the present invention may comprise at least one gas. The gas may be a gas reactant or a carrier gas. In one example, the gas may be a carrier gas that may be an inert gas. In particular, the inert gas may be selected from the group consisting of Ar and N₂. In another example, the gas component may comprise a gas that may be a reactant. In this example, the gas may be selected from the group consisting of H₂, CO, F₂, and Cl₂. In one example, the gas may be fed into the reactor. In at least one example, where O₂ may be present as a reactant, there may be another gas present that may be considered the gas component according to any aspect of the present invention.

The reactor according to any aspect of the present invention may comprise
a) a liquid container comprising the solid component according to any aspect of the present invention connected to a first end of a first feed line, the first container connected in fluid communication to a first pump;
b) a gas container connected to a first end of a second feed line; and
c) an outflow container where the target product is collected.

In another example, there is only one container used to hold the liquid, gas and solid components. In this example, the container has two separate feed lines, the first feed line feeding the liquid component according to any aspect of the present invention into the container and the second feed line feeding the gas component into the container. The pumps present in the reactor according to any aspect of the present invention may be peristaltic pump.

The reactor according to any aspect of the present invention may be operated in an up-flow or down-flow operation mode.

According to a further aspect of the present invention, there is provided a method of reacting at least one aqueous organic compound in a triphasic reaction mixture, wherein the reaction mixture comprises at least one solid, at least one liquid and at least one gaseous component, wherein
(i) the solid component is (a) a catalytically active composite based on (b) at least one perforated and permeable support, wherein the catalytically active composite is on at least one side of the support and inside the support and
   (a) the catalytically active composite is obtained by applying a suspension comprising at least one inorganic component of
      a compound of at least one of the elements Ce, La Sc, Y, Ti, Zr, Hf, Rf, V, Nb, Ta, Db, Cr, Mo, W, Sg, Mn, Tc, Re, Bh, Fe, Co, B, Al, In, Tl, Si, Ge, Sn, Pb, Sb and Bi with at least one of the elements Te, Se, S, O, Sb, As, P, N, Ge, Si, C and Ga and/or
      a compound of one of the elements Ti, Zr, Al, Ce and Si with oxygen, and/or
      a metal selected from Pt, Rh, Ru, Ir, Cu, Ni, Co, Mg, Zn, Al and Pd,
   in suspension in a sol, and
   (b) the support comprises fibers of at least one material selected from the group consisting of carbon, metal, alloy, ceramic, glass, mineral, plastic, amorphous substance, composite, natural product, and a combination thereof and heating the support at least once to a temperature of between 100 to 800° C. for 10 minutes to 5 hours, during which the suspension comprising the inorganic component is solidified on and inside the support;
(ii) the liquid component comprises the aqueous organic compound, and
(iii) the gaseous component comprises at least one gas.

The organic compound according to any aspect of the present invention may be oxidised or reduced. In one example, the inorganic component may be a compound of elements Ti and Si or a metal Pd. In particular, when the organic compound according to any aspect of the present invention is to be oxidised, the solid component may comprise an inorganic component that may be a compound of elements Ti and Si. In other example, when the organic compound according to any aspect of the present invention is to be reduced, the solid component may comprise an inorganic component of metal Pd.

According to another aspect of the present invention, there is provided a method of reacting at least one organic compound in a triphasic reaction mixture, wherein the method is carried out in a reactor according to any aspect of the present invention.

According to yet another aspect of the present invention, there is provided a use of a triphasic reactor according to any aspect of the present invention for oxidizing or reducing at least one organic compound.

### EXAMPLES

The foregoing describes preferred embodiments, which, as will be understood by those skilled in the art, may be subject to variations or modifications in design, construction or operation without departing from the scope of the claims. These variations, for instance, are intended to be covered by the scope of the claims.

### Example 1 (Comparative Example)

A titanium-silicate fixed bed catalyst was employed. The titanium-silicate powder was shaped into 2 mm extrudates using a silica sol as binder in accordance with Example 5 in EP00106671.1. The H₂O₂ employed was prepared according to the anthrachinone process including concentration as a 60 wt-% aqueous solution.

Epoxidation was carried out continuously in a reaction tube of 12 ml volume and a diameter of 16 mm, filled with 7.4 g titanium-silicate catalyst. The equipment comprised of three containers for liquids, relevant pumps and a liquid separating vessel. The three containers for liquids comprised methanol, 60% H₂O₂ and propene respectively. The 60% H₂O₂ was adjusted with ammonia to a pH of 4.5. The reaction temperature was controlled via an aqueous cooling liquid circulating in a cooling jacket whereby the cooling liquid temperature was controlled by a thermostat. The reactor pressure was 25 bar absolute. Mass flow of the feeding pumps was adjusted to result in a propene feed concentration of 40.0 wt-%, a methanol feed concentration of 46 wt-% and an H₂O₂ feed concentration of 8.0 wt-%. The reactor was operated in down-flow operation mode. A stream of nitrogen, to dilute the formed oxygen from H₂O₂ decomposition was fed to the reactor at 1 Nl/h.

The temperature measured inside the catalyst bed was 50° C. The flow rate was 50 g/h. Product output was determined by gas chromatography and the H₂O₂ conversion by titration. On the basis of the gas chromatographical analysis of the hydrocarbons the selectivity was calculated. It was calculated based on the amount of propene oxide formed relative to the amount of all oxygen containing hydrocarbons formed. The H₂O₂ conversion was 50%, the selectivity was 98.5%. The total yield therefore was 49.3%.

### Example 2

### Oxidation of Propene Using Textile Catalyst (TexCat 1)

3.4 g titanium-silicate powder catalyst was bound to 0.16 m² of a textile to form the textile catalyst used in this example. The titanium catalyst was produced according to U.S. Pat. No. 4,410,501. The production of the titanium silicalite is effected by forming a synthesis gel starting from a hydrolysable silicon compound such as for example tetraethyl orthosilicate and a hydrolysable titanium compound by addition of tetra-n-propyl ammonium hydroxide, followed by hydrolysis and crystallisation of this reaction mixture. After completion of the crystallisation the crystals are separated by filtration, washed, dried and finally calcined for 6 hours at 550° C.

In particular, the ingredients of the textile catalyst (TexCat 1) used in this example are provided in Table 1 below. First, the support, the glass cloth, was prepared by thoroughly rinsing the glass cloth with deionised water (at least 24 h). Then the glass support was heated for 1 h at 400° C. The Texcat 1 mixture of binders and particles was then prepared according to the recipe provided in Table 1 below. The glass support was then coated with the Texcat 1 mixture of binders and particles with a speed of 2.5 m/min. This coated glass support was left to dry for 1-2 h at 22° C. Finally, the TexCat 1 was calcined for 1 h at 570° C. The TexCat 1 was then ready for use.

TABLE 1
Recipe for Suspension of TexCat 1

| | | | TexCat 1 Recipe of mixture of | |
|---|---|---|---|---|
| | | | binders and particles | |
| | | | HyML180917ETC | |
| TexCat 1 | | | Recipe for Silane | |
| General Requirements | | Order | Amount | 81.72 g |
| Name of Suspension | HyML180917ETC | 5. | Deionised Water | 20.42 g |
| | TS-1 Specialist | | | |
| Catalyst | 2050 C5AZ00256 | 1. | Ethanol | 20.42 g |
| Amount | 75 g | 2. | MTES | 9.38 g |
| Solid percentage | 25% | 3. | TEOS | 9.38 g |
| Requirements for Silane | | 4. | GLYEO | 22.09 g |
| Proportion of Methyltriethoxysilane | 1 | | | |
| (MTES) | | 6. | HNO₃ | 0.041 g |
| | | | Silanes to be mixed for minimum | |
| | | | of 1.5 hours, best for 24 hours | |
| Proportion of Tetraethyl | 1 | | before being mixed with the Base | |
| orthosilicate (TEOS) | | | below. | |
| Proportion of 3- | | | | |
| Glycidyloxypropyltriethoxysilane | 2 | | | |
| (GLYEO) | | | Recipe for Base | |
| Proportion of HNO₃ to solids | 0.10% | Order | Amount | 300.00 g |
| Proportion of Silanes to solids | 50% | 3. | Titanium silicate | 75.00 g |
| Silane supplements(on top) | 0% | 1. | Deionised water | 180.00 g |
| Requirements for Base | | 2. | Ethanol | 45.00 g |
| | Σ = 1 | | Dispersant-Dolapix CE | |
| Proportion of Deionised Water | 0.8 | | 64 (Zschimmer and | |
| Proportion of Ethanol | 0.2 | | Schwarz Ransbach- | |
| | | 4. | Baumbach Germany | 0.150 g |
| | | 5. | HNO₃ | 0.690 g |
| Proportion of Dolapix to solids | 0.20% | | Sufficient sonication, stirring time | |
| | | | 24 h, after the addition of silanes | |
| Proportion of HNO₃ to solids | 0.92% | | min. 16 h/max. 72 h. | |
| | | | Dry weight of textile | 78.6% |
| | | | catalyst | |

Epoxidation is carried out continuously in a reaction tube. The reaction tube had a diameter of 65 mm and a length of 200 mm. The textile catalyst was winded in 4 layers, each were 0.24 mm thick with a width of 791 mm and a length of 198 mm, on a stainless steel cylinder with a diameter of 60 mm and a length of 198 mm. Therefore the overall volume of the textile catalyst was 40 ml with a length of 198 mm. The equipment further comprised of three containers for liquids, relevant pumps and a liquid separating vessel. The three containers for liquids comprised methanol, 60% H₂O₂ and propene. The 60% H₂O₂ was adjusted with ammonia to a pH of 4.5. The reaction temperature was controlled via an aqueous cooling liquid circulating in a cooling jacket whereby the cooling liquid temperature was controlled by a thermostat. The reactor pressure was 25 bar absolute. Mass flow of the feeding pumps was adjusted to result in a propene feed concentration of 40.0 wt-%, a methanol feed concentration of 46 wt-% and H₂O₂ feed concentration of 8.0 wt-%. The reactor was operated in up-flow operation mode. A stream of nitrogen, to dilute the formed oxygen from H₂O₂ decomposition was fed to the reactor at 1 Nl/h.

The temperature measured inside the catalyst bed was 55° C. The flow rate was 50 g/h. Product output was determined by gas chromatography and the H₂O₂ conversion by titration. On the basis of the gas chromatographical analysis of the hydrocarbons the selectivity was calculated. It was calculated based on the propene oxide formed relative to the amount of all oxygen containing hydrocarbons formed. The H₂O₂ conversion was 70%, the selectivity was 99.2%. The total yield therefore was 69.4%.

As can be observed, the conversion, selectivity and yield was significantly higher in Example 2 compared with example 1 that uses a different catalyst.

### Example 3 (Comparative Example)

Hydrogenation was carried out continuously in a reaction tube/reactor with a reactor volume of 5 ml. The reaction tube was part of a plant for carrying out the hydrogenation where the plant comprised a liquid reservoir, the reaction tube and a liquid separator. A supported catalyst, namely palladium on Al₂O₃(SA 5151, Norton, Akron, Ohio) was employed as the catalyst; the average particle size of the granule-like supported catalyst was 1-2 mm, the particle density 0.6 g/l. The height of the fixed bed catalyst was 25 mm in the reaction tube. The reaction temperature was established via a heat transfer oil circulation. The pressure and stream of hydrogen into the reaction tube were regulated electronically. The working solution was metered into a stream of hydrogen with a pump, and the mixture was introduced into the bottom of the hydrogenation reaction tube in a bubble column procedure. After flowing through the reaction tube/reactor, the product was removed from the separator at regular intervals. The working solution based on mainly alkylaromatics and tetrabutylurea comprised as the reaction carrier 2-ethyltetrahydroanthraquinone in a concentration of 87.8 g/l and ethylanthraquinone in a concentration of 33 g/l. The reactor pressure was 0.5 MPa. The liquid loading LHSV was 4 h<−1>, the reactor temperature 61° C. The stream of hydrogen fed to the reactor was 10 Nl/h.

An aqueous palladium nitrate solution was employed for charging the support. 100 g of the support material was initially introduced into a coating pan and a solution of 29 g water and 0.22 g palladium nitrate was poured over the material in the rotating pan. The coated support was air dried for 16 h and then heated up to 200° C. in a tubular oven. The catalyst was subsequently reduced with hydrogen at 200° C. for 8 h and then washed three times with 40 ml distilled water each time. In the end, the reactor contained 5 ml×0.6 g/ml×2 g/1000 g=6 mg Pd

| | | | H₂O₂ equivalent |
|---|---|---|---|
| No. | Flow direction | Operating time [h] | concentration [g/l] |
| CE1 | Upwards | 22 | 6.4 |
| CE2 | Upwards | 214 | 6.4 |

The experiments show that in the H₂O₂ equivalent concentration remains constant over the operating time. Therefore 20 g/h×6 g/1000 g=0.12 g H₂O₂/h was produced. That means 20 mg H₂O₂/mgPd/h was produced.

### Example 4

Reduction of H₂O₂ Using Textile Catalyst (TexCat 2) 92 mg of a powder containing 2 wt % Palladium on alumina (Evonik Industries under the Noblyst® trade name) was fixed on 0.0045 m² of a textile forming the textile catalyst (TexCat 2) in the reactor of this example.

First, the support, polyphenylene sulphide (PPS) non-woven fabric, was prepared. The Texcat 2 mixture of binders and particles was then prepared according to the recipe provided in Table 2 below. The fabric support was then coated with the Texcat 2 mixture of binders and particles with a speed of 2.5 m/min. This coated fabric support was left to dry for 1-2 h at 22° C. Finally, the TexCat 2 was calcined for 1 h at 120° C. The TexCat 2 was then ready for use.

TABLE 2
Recipe for Suspension of TexCat 2

| | | | TexCat 2 Recipe of mixture of | |
|---|---|---|---|---|
| | | | binders and particles | |
| TexCat 2 | | | HyML180917ETC | |
| | | | Recipe for Silane | |
| General Requirements | | Order | Amount | 44.29 g |
| Name of Suspension | HyML180116HTC | 5. | Deionised Water | 11.07 g |
| | PMC170402 | | | |
| Catalyst | (SP1070D) | 1. | Ethanol | 11.07 g |
| Amount | 100 g | 2. | MTES | 4.00 g |
| Solid percentage | 21.5% | 3. | TEOS | 4.00 g |
| Requirements for Silane | | 4. | GLYEO | 14.14 g |
| Proportion of Methyltriethoxysilane | 1 | 6. | HNO₃ | 0.022 g |
| (MTES) | | | | |
| | | | Silanes was mixed for minimum of | |
| Proportion of Tetraethyl orthosilicate | 1 | | 1.5 hours, best for 24 hours before | |
| (TEOS) | | | being mixed with the Base below. | |
| Proportion of 3- | | | | |
| Glycidyloxypropyltriethoxysilane | 3 | | | |
| (GLYEO) | | | Recipe for Base | |
| Proportion of HNO₃ to solids | 0.10% | Order | Amount | 465.12 g |
| | | | 2 wt % Palladium on | |
| Proportion of Silanes to solids | 20% | 3. | alumina | 100.00 g |
| Silane supplements(on top) | 0% | 1. | Deionised water | 211.77 g |
| Requirements for Base | | 2. | Ethanol | 153.35 g |
| | Σ = 1 | | Dispersant- Dolapix CE | |
| Proportion of Deionised Water | 0.8 | | 64 (Zschimmer and | |
| Proportion of Ethanol | 0.2 | | Schwarz | |
| | | | Ransbach-Baumbach | |
| | | 4. | Germany) | 0.200 g |
| Proportion of Dolapix to solids | 0.20% | 5. | HNO₃ | 0.92 g |
| | | | Sufficient sonication, stirring time | |
| Proportion of HNO₃ to solids | 0.92% | | 24 h, after the addition of silanes | |
| | | | min. 16 h/max. 72 h. | |
| | | | Dry weight of textile | 90.0% |
| | | | catalyst | |

Hydrogenation was carried out continuously in a reaction tube/reactor with a reactor volume of 100 ml. The reaction tube was a stirring vessel which was part of a plant for carrying out hydrogenation where the plant comprised a liquid reservoir, a reactor and a liquid separator. The reaction temperature was established via a heat transfer oil circulation. The pressure was kept constant at 0.1 MPa by feeding H₂ gas. 92 mg of a powder containing 2 wt % Palladium was fixed on 0.0045 m² of a textile forming the textile catalyst in the reactor. After flowing through the reactor, the product was removed from the separator at regular intervals. The working solution based on mainly alkylaromatics and tetrabutylurea comprised as the reaction carrier 2-ethyltetrahydroanthraquinone in a concentration of 87.8 g/l and ethylanthraquinone in a concentration of 33 g/1. The reactor temperature was maintained at 60° C.

A ta residence time of the liquid of one hour 0.21 hydrogen was consumed. Therefore, with the textile catalyst, 0.2 IH₂/h/100 mgCat=0.2 IH₂/h/mgPd/h=142 mg H₂O₂/mgPd/h was produced.

More than five times more H₂O₂ was produced using the textile catalyst compared to other catalyst in Example 3.

1-15. (canceled)

16. A triphasic single reactor comprising a solid, a liquid and a gaseous component, wherein:
(i) the solid component is a catalytically active composite based on at least one perforated and permeable support, wherein the catalytically active composite is on at least one side of the support and inside the support, and wherein:
(a) the catalytically active composite is obtained by applying a suspension comprising at least one inorganic component of:
a compound comprising at least one element selected from the group consisting of: Ce; La; Sc; Y; Ti; Zr; Hf; Rf; V; Nb; Ta; db; Cr; Mo; W; Sg; Mn; Tc; Re; Bh; Fe; Co; B; Al; In; Tl; Si; Ge; Sn; Pb; Sb; and Bi; with at least one element selected from the group consisting of: Te; Se; S; O; Sb; As; P; N; Ge; Si; C; and Ga; and/or
a compound comprising at least one element selected from the group consisting of: Ti; Z; Al; Ce; and Si; with oxygen, and/or
a metal selected from the group consisting of: Pt; Rh; Ru; Ir; Cu; Ni; Co; Mg; Zn; Al; and Pd;
in suspension in a sol, and
(b) the support comprises fibers of at least one material selected from the group consisting of; carbon; metal; alloy; ceramic; glass; mineral; plastic; amorphous substance; composite; natural product; and a combination thereof; and wherein the support is heated at least once to a temperature of between 100 to 800° C. for 10 minutes to 5 hours, during which the suspension comprising the inorganic component is solidified on and inside the support.

17. The reactor of claim 16, wherein:
(ii) the liquid component comprises an aqueous reaction solution; and
(iii) the gas component comprises at least one gas.

18. The reactor of claim 16, wherein the catalytically active composite in the solid component is capable of being wound on or off a roll.

19. The reactor of claim 16, wherein the gaseous component is an inert gas.

20. The reactor of claim 17, wherein the gas is selected from the group consisting of: Ar and N₂.

21. The reactor of claim 16, wherein the liquid component is an aqueous reaction solution that comprises at least one organic compound that is to be used as a substrate in the reaction.

22. The reactor of claim 21, wherein the organic compound is selected from the group consisting of: alkanes; alkenes; carboxylic acids; dicarboxylic acids; hydroxycarboxylic acids; carboxylic acid esters; hydroxycarboxylic acid esters; alcohols; aldehydes; ketones; amines; and amino acids.

23. The reactor of claim 16, wherein the support of the solid component is heated at least once to a temperature of between 100 to 500° C. for at least 1 hour.

24. The reactor of claim 16, wherein the reactor is operated in an up-flow or down-flow operation mode.

25. The reactor of claim 16, wherein the composite comprises at least one oxide from at least one element selected from the group consisting of: Mo; Sn; Zn; V; Mn; Fe; Co; Ni; As; Sb; Pb; Bi; Ru; Re; Cr; W; Nb; Hf; La; Ce; Gd; Ga; In; Tl; Ag; Cu; Li; K; Na; Be; Mg; Ca; Sr; and Ba.

26. The reactor of claim 18, wherein the liquid component is an aqueous reaction solution that comprises at least one organic compound that is to be used as a substrate in the reaction.

27. The reactor of claim 26, wherein the organic compound is selected from the group consisting of: alkanes; alkenes; carboxylic acids; dicarboxylic acids; hydroxycarboxylic acids; carboxylic acid esters; hydroxycarboxylic acid esters; alcohols; aldehydes; ketones; amines; and amino acids.

28. The reactor of claim 27, wherein the composite comprises at least one oxide from at least one element selected from the group consisting of: Mo; Sn; Zn; V; Mn; Fe; Co; Ni; As; Sb; Pb; Bi; Ru; Re; Cr; W; Nb; Hf; La; Ce; Gd; Ga; In; Tl; Ag; Cu; Li; K; Na; Be; Mg; Ca; Sr; and Ba.

29. A method of reacting at least one aqueous organic compound in a triphasic reaction mixture, wherein the reaction mixture comprises at least one solid, at least one liquid and at least one gaseous component, wherein:
(i) the solid component is a catalytically active composite based on at least one perforated and permeable support, wherein the catalytically active composite is on at least one side of the support and inside the support; and wherein:
(a) the catalytically active composite is obtained by applying a suspension comprising at least one inorganic component of:
a compound of at least one of the elements: Ce; La; Sc; Y; Ti; Zr; Hf; Rf; V; Nb; Ta; db; Cr; Mo; W; Sg; Mn; Tc; Re; Bh; Fe; Co; B; Al; In; Tl; Si; Ge; Sn; Pb; Sb; and Bi; with at least one of the elements; Te; Se; S; O; Sb; As; P; N; Ge; Si; C; and Ga; and/or
a compound of one of the elements: Ti; Zr; Al; Ce; and Si; with oxygen, and/or
a metal selected from: Pt; Rh; Ru; Ir; Cu; Ni; Co; Mg; Zn; Al; and Pd;
in suspension in a sol; and
(b) the support comprises fibers of at least one material selected from the group consisting of: carbon; metal; alloy; ceramic; glass; mineral; plastic; amorphous substance; composite; natural product; and a combination thereof and heating the support at least once to a temperature of between 100 to 800° C. for 10 minutes to 5 hours, during which the suspension comprising the inorganic component is solidified on and inside the support.
(ii) the liquid component comprises the aqueous organic compound; and
(iii) the gaseous component comprises at least one gas.

30. The method of claim 29, wherein the organic compound is oxidised or reduced.

31. The method of claim 29, wherein the inorganic component is a compound of Ti and Si or a metal Pd.

32. The method of claim 30, wherein the inorganic component is a compound of Ti and Si or a metal Pd.

33. A method of reacting at least one organic compound in a triphasic reaction mixture, wherein the method is carried out in the reactor of claim 16.

34. The method of claim 33, wherein the catalytically active composite in the solid component of the reactor is capable of being wound on or off a roll.

35. The method of claim 33, wherein the gas is selected from the group consisting of: Ar and N₂.
